(19) United States
(12) Patent Application Publication
(10) Pub. No.: US 2006/0176364 A1
(43) Pub. Date: Aug. 10, 2006

(54) Mobile communication apparatus capable of automatically capturing image data and method for automatically capturing image data thereof

(75) Inventors: Cheng-Shing Lai, Taipei (TW); Jias-Heng Mei, Nanking City (CN); Xiao-Long Fan, Nanking City (CN)

Correspondence Address: BRUCE H. TROXELL;SUITE 1404, 5205 LEESBURG PIKE, FALLS CHURCH, VA, 22041, US

(73) Assignee: Inventec Appliances Corp.

(21) Appl. No.: 11/041,959

(22) Filed: Jan. 26, 2005

(51) Int. Cl. H04N 7/14

(52) U.S. Cl. 348/14.01

(57) ABSTRACT

A mobile communication apparatus capable of automatically capturing image data is disclosed. The mobile communication apparatus includes a image capture device, a scheduling module and a transmitting module. The image capture device is used to capture a image data. The scheduling module forms an image capturing schedule and provides an image capturing program which controls the image capture device to capture the image data according to the image capturing schedule. The transmitting module transmits the image data captured by the image capture device to a predetermined receiver.

### BACKGROUND OF THE INVENTION

(1) Field of the Invention

The invention relates to a mobile communication apparatus capable of automatically capturing image data and a method for automatically capturing image data.

(2) Description of the Prior Art

As the prevalence of mobile communication apparatus, mobile phones have become the most common used electronic apparatus. On the other hand, with the popularity of the multimedia information, the design of current mobile communication apparatus tends to emphasize a variety of functions, particularly capable of playing multimedia video and audio files. FIG. 1 shows a schematic view depicting a traditional mobile communication apparatus 1 capable of capturing image data. The traditional mobile communication apparatus 1 is equipped with an image capture device 10 which enable the user 9 beside the mobile communication apparatus to take pictures or capture the desired images anywhere and anytime. In addition to being capable of storing the captured image data, through the communication linkage, the mobile communication apparatus 1 is able to transmit the captured image data to the other mobile communication apparatus 11. The other mobile communication apparatus 11 transfers the captured image data to a frame and then display it.

Traditionally, in order to capable of taking picture “anywhere and anytime”, the basic requirement is that the user 9 has to be adjacent to the mobile communication apparatus 1. Alternatively, the user 9, far way from the mobile communication apparatus 1, uses a short-distance remote controller to operate the mobile communication apparatus 1 to take picture. However, for the traditional mobile communication apparatus 1, if the user 9 is too far way from or not adjacent to the mobile communication apparatus 1, taking picture is unable to be achieved.

FIG. 2 shows a schematic view depicting the calendar function of prior art. The traditional mobile communication apparatus 1 includes a calendar module 2. The calendar module 2 is used to store reminder event inputted from an input interface 3 into a storage device 4 of the mobile communication apparatus 1. In addition, in response to some setting parameters inputted through the input interface 3, a scheduling module 7 makes the reminder event correspond to a predetermined time and stored them in the storage device 4. At the same time, a timer 6 is used to determine the current time. The scheduling module 7 determines whether the predetermined time expires according to the timer 6. If the scheduling module 7 determines that the predetermined time expires, a reminding interface 8 reminds the user 9 of the mobile communication apparatus 1 of the reminder event.

Obviously, for the traditional mobile communication apparatus 1, there are disadvantages in the above picture taking function and the calendar function. Therefore, the present invention discloses a mobile communication apparatus- capable of automatically capturing image data, which makes use of the exiting hardware, including the calendar module and the image capture device, to improve the disadvantages

### SUMMARY OF THE INVENTION

Accordingly, it is one object of the present invention to provide a mobile communication apparatus capable of automatically capturing image data and a method for automatically capturing image data. Through the present invention, the mobile communication apparatus is able to automatically take picture at precise time. Further, an user far away from the mobile communication apparatus is able to take picture.

It is another object of the present invention to provide a mobile communication apparatus capable of automatically capturing image data and a method for automatically capturing image data. Through the present invention, the captured image data is transmitted to the other mobile communication apparatus periodically and immediately.

A mobile communication apparatus capable of automatically capturing image data is disclosed. The mobile communication apparatus includes a image capture device, a scheduling module and a transmitting module. The image capture device is used to capture a image data. The scheduling module forms an image capturing schedule and provides an image capturing program which controls the image capture device to capture the image data according to the image capturing schedule. The transmitting module transmits the image data captured by the image capture device to a predetermined receiver.

Accordingly, through the present mobile communication apparatus capable of automatically capturing image the method for automatically capturing image thereof, the mobile communication apparatus is able to capture the image according to the desired time. Meanwhile, the mobile communication apparatus can be operated remotely. Further, the captured image can be sent to the other mobile communication apparatus periodically or immediately. This benefits not only the user but also increases the added value of the mobile communication apparatus.

### BRIEF DESCRIPTION OF THE DRAWINGS

The present invention will now be specified with reference to its preferred embodiment illustrated in the drawings, in which

FIG. 1 shows a schematic view depicting a traditional mobile communication apparatus capable of capturing image data;

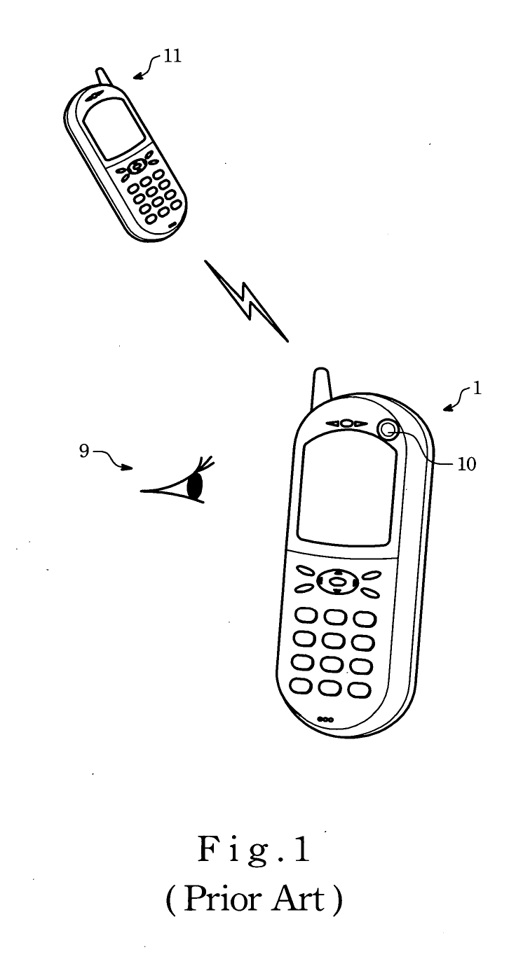

FIG. 2 shows a schematic view depicting the calendar function of prior art;

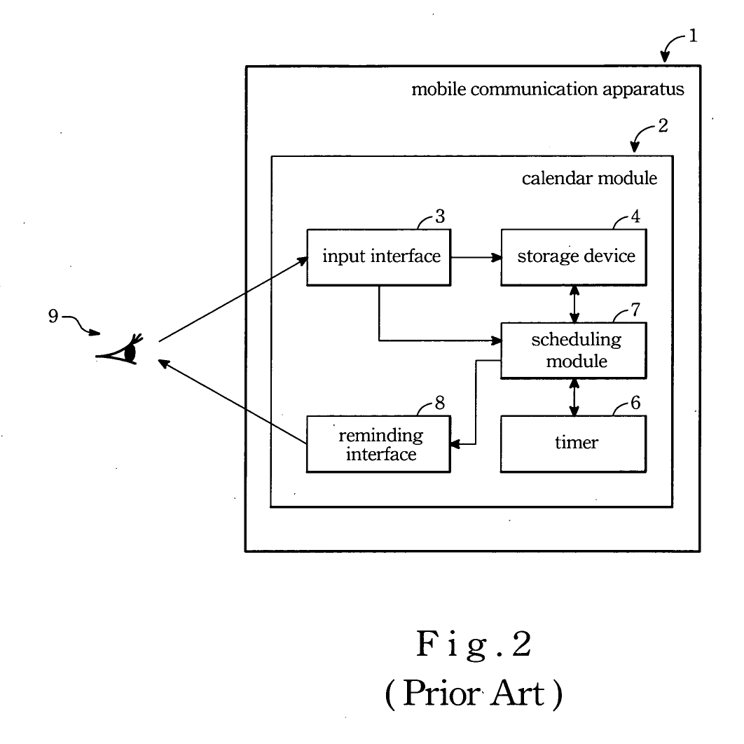

FIG. 3 shows a schematic view depicting the first embodiment of the present mobile communication apparatus;

FIG. 4 shows a schematic view depicting the second embodiment of the present mobile communication apparatus;

FIG. 5 shows a schematic view depicting the setting module of the present invention;

FIG. 6 shows the flowchart depicting the embodiment of the editing process; and

FIG. 7 shows the flowchart depicting the embodiment of the present invention.

### DESCRIPTION OF THE PREFERRED EMBODIMENT

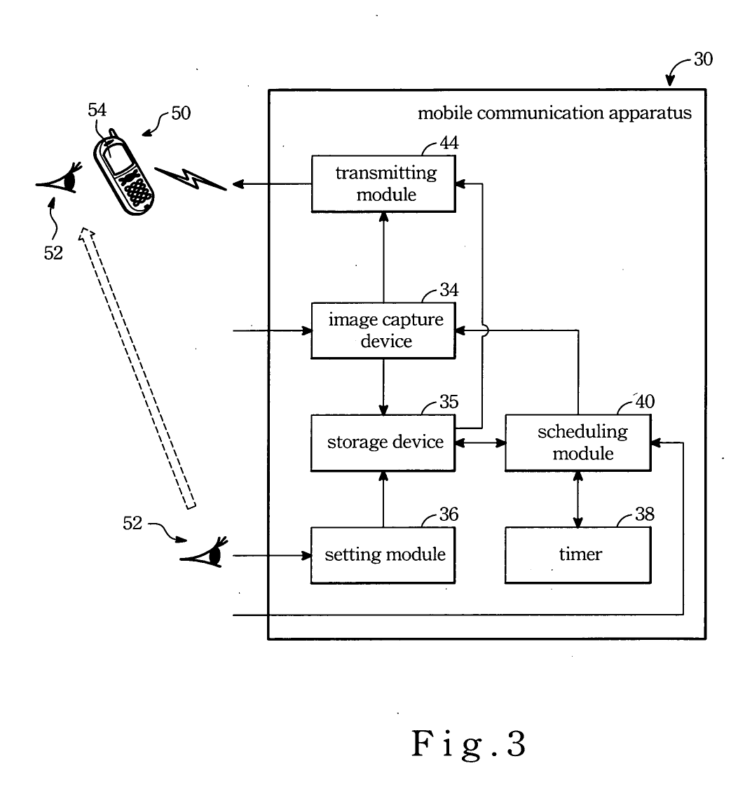

FIG. 3 shows a schematic view depicting the first embodiment of the present mobile communication apparatus 30. The present mobile communication apparatus 30 is able to automatically capture image data and provides it for the subsequent display. The present mobile communication apparatus 30 includes an image capture device 34, a setting module 36, a timer 38, a scheduling module 40, a transmitting module 44 and a storage device 35.

The image capture device 34 is used to capture image data and is able to store it in the storage device 35 of the mobile communication apparatus 30. The image capture device 34 can be a digital still camera or a digital video camera using CCD or CMOS as the image capture device. Through the scheduling module 40, a user 52 can make the desired image data correspond to the predetermined time so as to form an image capturing schedule. That is, through the scheduling module 40, the user 52 can designate the image data to be captured at the predetermined time. This corresponding is an event of the image capturing schedule. The predetermined time and the image capturing schedule can be stored in the storage device 35. The timer 38 is used to determine the current time. The scheduling module 40 determines whether the predetermined time expires according to the time determined by the timer 38. If the scheduling module 40 determines that the predetermined time expires, the image capture device 34 will automatically capture the image data.

On the other hand, the mobile communication apparatus 30 further includes a setting module 36, which is used to set a telephone number corresponding to a receiver 50. The telephone number is stored in the storage device 35 for the subsequent use of the transmitting module 44. If the scheduling module 40 determines that the predetermined time expires, the transmitting module 44 will transmit the image data captured by the image capture device 34 to the telephone number corresponding to the receiver 50. Therefore, the user 52 or the other users can see the image data transmitted by the mobile communication apparatus 30 from the receiver 50.

For the above mobile communication apparatus 30, after the image capture device 34 has captured the image data, if the predetermined time never occurs again, the image capturing schedule will be deleted by the scheduling module 40. For example, if the predetermined time is PM 05:00, 25 Dec., 1999, which will never occur again, the scheduling module 40 will delete the image capturing schedule corresponding to the image captured.

If the predetermined time is periodically repeatable, such as AM 08:00 of every Sunday, which will periodically occurs, the scheduling module 40 will keep the image capturing schedule. Further, the image data will be captured repeatedly according to the image capturing schedule.

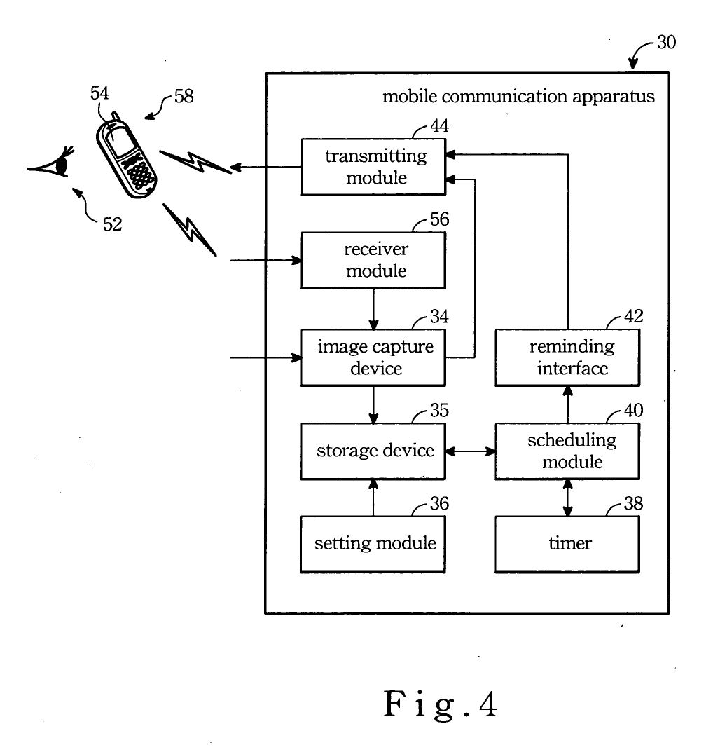

FIG. 4 shows a schematic view depicting the second embodiment of the present mobile communication apparatus 30. The present mobile communication apparatus 30 includes the image capture device 34, the setting module 36, the timer 38, the scheduling module 40, the transmitting module 44 and the storage device 35 shown in the first embodiment. The present mobile communication apparatus 30 further includes a reminding interface 42 and a receiver module 56. When the scheduling module 40 determines that the predetermined time expires, in addition to directly capturing the image data using the image capture device 34 as shown in the first embodiment, it is allowed to remind the user 52 of the information related to the image data to be captured using the reminding interface 42 shown in the second embodiment and transmit the user 52 of the remote communication apparatus 58 through the transmitting module 44.

Based on the reminder on the screen 54 of the remote communication apparatus 58 which displays the information related to the image data to be captured corresponding to the predetermined time, the distant user 52 is able to decide whether to use the mobile communication apparatus 30 to capture the image data. If the user 52 decides to take pictures, the remote communication apparatus 58 will send a command to the receiver module 56 of the mobile communication apparatus 30. Then, the image capture device 34 receives the command and captures the image data. Thereafter, the storage device 35 may store the captured image data. Alternatively, the transmitting module 44 transmits the captured image data To the remote communication apparatus 58 to show the captured image data for the user 52.

The reminding interface 42 can remind the user 52 of the remote communication apparatus 58 through voice or sound or the blinking screen 54. Alternatively, a variety of background colors of the screen 54 are usable to remind the user 52 of the remote communication apparatus 58.

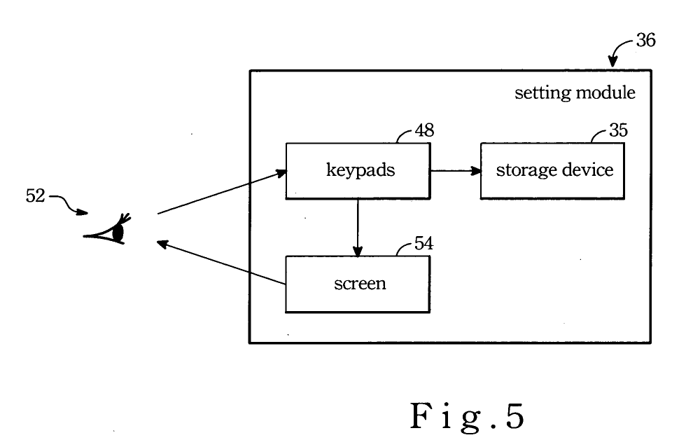

FIG. 5 shows a schematic view depicting the setting module 36 of the present invention. The setting module 36 includes keypads 48 and a screen 54. The keypads 48 are used for the user 52 to input the information, such as the telephone number corresponding to the image data to be captured, which will be stored in the storage device 35. The screen 54 is used to display the settings to the user 52 and the captured image data.

The method used by the present mobile communication apparatus 30 is described as follows. The method includes the following steps. Firstly, a predetermined time is designated to the image data to be captured by the scheduling module 40. That is, the image data will be captured at the corresponding predetermined time. In addition, a telephone number to be dialed is designated to the image data to be captured by the setting module 36. Then, the scheduling module 40 determines whether the predetermined time expires according to the timer 38. If the scheduling module 40 determines that the predetermined time expires, the image capture device 34 will directly capture the image data. The captured image data can be stored in the storage device 35 of the mobile communication apparatus 30. Alternatively, the transmitting module 44 transmits the captured image corresponding to the predetermined time to the receiver 50 represented by the dialed telephone number.

Alternatively, if the scheduling module 40 determines that the predetermined time expires, the reminding interface 42 will remind the user 52 of the remote communication apparatus 58, through the transmitting module 44, to decide whether capture the image data. If the user 52 decides to take pictures, the receiver module 56 will inform the image capture device 34 of the mobile communication apparatus 30 to capture the image data. The captured image data can be stored in the storage device 35. Alternatively, the transmitting module 44 transmits the captured image corresponding to the predetermined time to the remote communication apparatus 58 represented by the dialed telephone number.

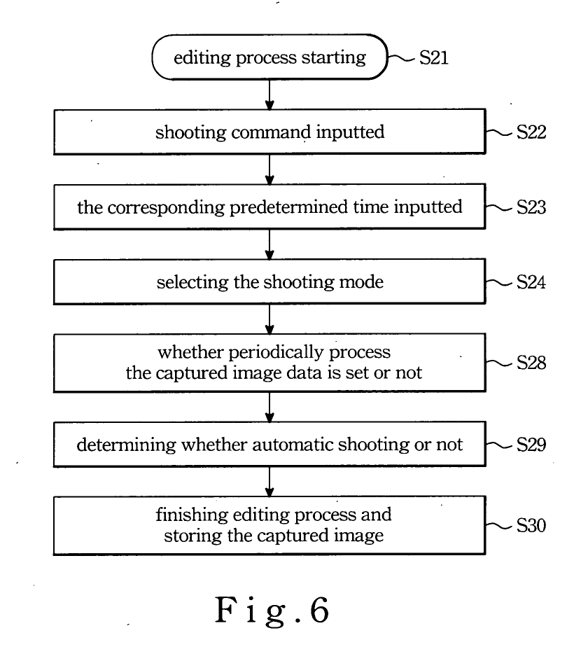

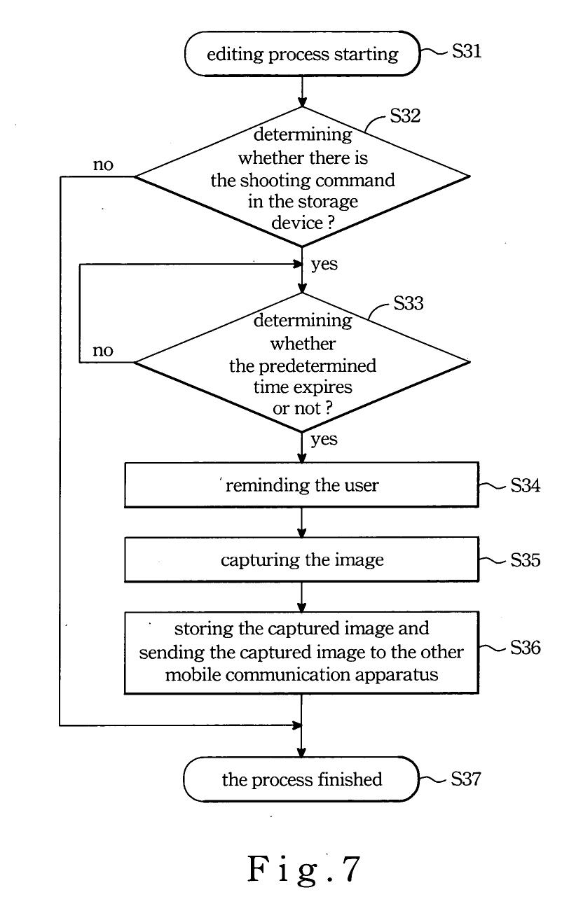

The whole flowchart of the method for automatically capturing image of the present mobile communication apparatus 30 is described above. In fact, the whole flowchart of the method includes editing process and automatically capturing image data. The editing process and the whole operation of the automatically capturing image data are described with the following FIG. 6 and FIG. 7. FIG. 6 shows the flowchart depicting the embodiment of the editing process. At first, as the step S21, the editing process is started. Then, as the step S22, a shooting command is inputted. As the step S23, the predetermined time corresponding to the shooting command is inputted. As the step S24, the shooting mode, such as the still mode or the movie mode, is selected to capture the image data. Thereafter, as the step S28, determining whether periodically process the captured image data is set. If the predetermined time includes the week, the hour, the minute and the second, it is suitable to set periodically processing the captured image. However, if the predetermined time just includes the year and the month without the week, the hour, the minute and the second, it is not suitable to set periodically processing the captured image. As the step S29, determining whether automatic shooting or not. As the step S30, the editing process is finished and the captured image is stored in the storage device 35.

FIG. 7 shows the flowchart depicting the embodiment of the present invention. As the step S31, the editing process is started. Firstly, as the step S32, determining whether there is the desired image in the storage device 30. If not, as the step S37, the process is finished. If yes, the step S33, determining whether the predetermined time expires, is performed. If the predetermined time expires, as the step S34, the user 52 is reminded of the information about the image to capture by the reminding interface 42. This step further allows the user 52 to decide whether to take picture. Thereafter, the step S35, capturing the image, is performed. The step S36, storing the captured image in the storage device 35 of the mobile communication apparatus 30. Alternatively, the captured image is sent to the other mobile communication apparatus 58 by the transmitting module 44. Then, the process is finished in the step 37.

Accordingly, through the present mobile communication apparatus 30 capable of automatically capturing image the method for automatically capturing image thereof, the mobile communication apparatus 30 is able to capture the image according to the desired time. Meanwhile, the mobile communication apparatus 30 can be operated remotely. Further, the captured image can be sent to the other mobile communication apparatus 58 periodically or immediately. This benefits not only the user but also increases the added value of the mobile communication apparatus 30.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A mobile communication apparatus capable of automatically capturing image data, comprising:
a image capture device, used to capture a image data;
a scheduling module, forming an image capturing schedule and providing an image capturing program which controls the image capture device to capture the image data according to the image capturing schedule; and
a transmitting module, used to transmit the image data captured by the image capture device to a predetermined receiver.

2. The mobile communication apparatus according to claim 1, further comprises a setting module, used to set a telephone number corresponding to the predetermined receiver.

3. The mobile communication apparatus according to claim 1, further comprises a reminding interface further for sending a message to an user of a remote mobile communication apparatus for reminding if the predetermined time expires.

4. The mobile communication apparatus according to claim 1, wherein the scheduling module will delete the image capturing schedule after the image capture device has captured the image data if the predetermined time will never occurs again.

5. The mobile communication apparatus according to claim 1, wherein the scheduling module will keep the image capturing schedule after the image capture device has captured the image data if the predetermined time is periodically repeated.

6. The mobile communication apparatus according to claim 1, wherein the image capture device is a digital still camera.

7. The mobile communication apparatus according to claim 1, wherein the image capture device is a digital video camera.

8. A method for automatically capture image used in a mobile communication apparatus capable of automatically capturing image, comprising the steps as follows:
providing an image capturing schedule;
capturing an image data according to the image capturing schedule; and
transmitting the captured image to a predetermined receiver.

9. The method according to claim 8, further comprises the step predetermining a telephone number corresponding to the predetermined receiver so as to transmit the captured image to the predetermined receiver.

10. The method according to claim 8, further comprises the step sending a message to an user of a remote mobile communication apparatus for reminding if the predetermined time expires.

11. The method according to claim 11, wherein the scheduling module will delete the image capturing schedule after the image capture device has captured the image data if the predetermined time will never occurs again.

12. The method according to claim 11, wherein the scheduling module will keep the image capturing schedule after the image capture device has captured the image data if the predetermined time is periodically repeated.

13. The method according to claim 8, wherein the image capture device is a digital still camera.

14. The method according to claim 8, wherein the image capture device is a digital video camera.
